(19) United States
(12) Patent Application Publication
(10) Pub. No.: US 2006/0156770 A1
(43) Pub. Date: Jul. 20, 2006

(54) Restraining plate cooperating with a locking/unlocking control bar for use in a door lock mechanism

(75) Inventors: Lan-Shi Huang, Kaohsiung (TW); Kuang-Chun Chiang, Kaohsiung (TW)

Correspondence Address: BIRCH STEWART KOLASCH & BIRCH, PO BOX 747, FALLS CHURCH, VA, 22040-0747, US

(73) Assignee: Taiwan Fu Hsing Industrial Co., Ltd.

(21) Appl. No.: 11/384,394

(22) Filed: Mar. 21, 2006

Related U.S. Application Data
(63) Continuation-in-part of application No. 10/820,116, filed on Apr. 8, 2004.

(51) Int. Cl. E05B 13/10

(52) U.S. Cl. 70/224

(57) ABSTRACT

A door lock mechanism includes a rose escutcheon having a mounting plate and two positioning plates provided on a side thereof, a door handle rotatably extending through the rose escutcheon and the mounting plate, a spindle including a first end securely attached to the handle, and a return disc mounted to a second end of the spindle. The return disc includes an annular wall and a notch. A return spring is received in the annular wall and extends through the notch of the return disc, with two ends of the return spring being respectively attached to the positioning plates of the mounting plate of the rose escutcheon for returning the handle. Since the return spring is directly received in the annular wall of the return disc, a compact design is provided. The door lock mechanism further includes a restraining plate and a locking/unlocking control bar cooperating with the restraining plate.

### CROSS REFERENCE TO RELATED APPLICATION

This application is a continuation-in-part application of U.S. patent Ser. No. 10/820,116, filed on Apr. 8, 2004.

### BACKGROUND OF THE INVENTION

1. Field of the Invention

The present invention relates to a restraining plate structure for use in a door lock mechanism. In particular, the present invention relates to a restraining plate of a door lock mechanism formed with a one-piece member. More particularly, the present invention relates to a door lock mechanism having a restraining plate cooperating with a locking/unlocking control bar for locking or unlocking operation.

2. Description of Related Art

A typical conventional door lock mechanism comprises a door handle, a spindle having an end securely attached to the door handle to turn therewith, a return disc mounted around the other end of the spindle, and a return spring mounted around the return disc for returning the door handle and the spindle. The return spring has two ends that are respectively attached to a mounting plate of a rose escutcheon through which the door handle is rotatably extended. However, mounting of the return spring around the return disc is not easy and fails to provide a compact design. The present invention is intended to provide an improved door lock mechanism to solve these problems.

In addition, the conventional door lock mechanism comprises a restraining assembly and a locking/unlocking control bar. The locking/unlocking control bar controls the restraining assembly to reciprocate between a lock position and an unlocked position in locking and unlocking operation. The restraining assembly may be formed with a sophisticated structure, and is received in a slot of the spindle which is combined with the door handle for turning operation. In the lock state, the restraining assembly is located in the lock position, and is engaged with positioning grooves of the rose escutcheon such that the door handle cannot be turned. In the unlocked state, the restraining assembly is located in the unlocked position, and is disengaged from the positioning grooves of the rose escutcheon such that the door handle can be turned to open the door. However, a number of design limitations exist for the restraining assembly due to (1) difficulties in manufacturing; (2) reasonable cost saving in manufacturing; and (3) stress on the restraining assembly during prolonged use. If the problematic aspects of the restraining assembly is not properly eliminated, it may cause distortion of the restraining assembly from its design shape, malfunction or fail in operation.

Hence, there is a further need for providing an improved structure of the conventional restraining assembly that is simplified in manufacturing. This means that a simplified operation in manufacture is required in the art, and the restraining assembly should be also achieved at a relatively reasonable cost.

The present invention is further intended to provide a simplified design of the restraining plate cooperating with a locking/unlocking control bar for locking or unlocking operation in such a way as to mitigate and overcome the above problem.

### OBJECTS OF THE INVENTION

An object of the present invention is to provide a door lock mechanism with a simplified structure of a restraining plate achieved at a single punching operation.

Another object of the present invention is to provide a door lock mechanism with a compact thin-wall design of the restraining plate to be received in a rose escutcheon.

A further object of the present invention is to provide a door lock mechanism with improved structural strength of the restraining plate that permits a minimum use of material.

A yet further object of the present invention is to provide a door lock mechanism having an overall structure of the restraining plate achieved at a relatively reasonable cost.

A yet further object of the present invention is to provide a restraining plate of the door lock mechanism having at least one neck portion to engage with an engaging slot of a spindle.

### SUMMARY OF THE INVENTION

In accordance with an aspect of the present invention, a door lock mechanism comprises a rose escutcheon including a mounting plate and two positioning plates formed on a side thereof, a door handle rotatably extending through the rose escutcheon and the mounting plate, a spindle including a first end securely attached to the door handle, and a return disc mounted to a second end of the spindle. The return disc includes an annular wall and a notch. A return spring is received in the annular wall and extends through the notch of the return disc, with two ends of the return spring being respectively attached to the positioning plates of the rose escutcheon for returning the door handle. Since the return spring is directly received in the annular wall of the return disc, a compact design is provided.

In an embodiment of the invention, the return disc includes a flange, and the mounting plate of the rose escutcheon includes a stepped portion for engaging with the flange of the return disc, providing improved structural strength of the door lock mechanism.

The return spring may be coaxially received in the annular wall of the return disc. In accordance with a separate aspect of the present invention, the door lock mechanism includes a restraining plate and a locking/unlocking control bar in cooperation with the restraining plate. The restraining plate is constructed from a main body which includes two engaging pieces extended therefrom and an 8-shaped, elongated hole formed therein. Formed in the 8-shaped, elongated hole are a pair of limiting inner edges, a pair of inclined guide peripheries, a pair of positioning recesses and a pair of V-shaped grooves. Correspondingly, the locking/unlocking control bar includes a pair of lobes integrally formed thereon. The lobes of the locking/unlocking control bar rest in the V-shaped grooves of the restraining plate when the restraining plate is located in an unlocked position. Turning the locking/unlocking control bar cause the lobes to pass through the inclined guide peripheries of the restraining plate. Conversely, the lobes of the locking/unlocking control bar rest in the positioning recesses of the restraining plate when the restraining plate is changed to a lock position.

In an embodiment of the invention, the restraining plate includes a neck portion integrally connected between the main body and the engaging piece.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a door lock mechanism in accordance with the present invention;

FIG. 1A is an exploded perspective view illustrating a door handle, a restraining plate and a locking/unlocking control bar of the door lock mechanism in accordance with a first embodiment of the present invention;

FIG. 2A is a front plan view illustrating the restraining plate, as depicted in FIGS. 1 and 1A, for use in the door lock mechanism in accordance with the first embodiment of the present invention;

FIG. 2B is a right side elevational view illustrating the restraining plate, as depicted in FIG. 2A, for use in the door lock mechanism in accordance with the first embodiment of the present invention;

FIG. 2C is a top plan view illustrating the restraining plate, as depicted in FIG. 2A, for use in the door lock mechanism in accordance with the first embodiment of the present invention;

FIG. 3 is a cross-sectional view of the door lock mechanism in accordance with the present invention, wherein the door lock mechanism is in an unlocked state; FIG. 4 is another cross-sectional view, taken along line 4-4 in FIG. 3, illustrating the door lock mechanism in accordance with the first embodiment of the present invention, wherein the door lock mechanism is in the unlocked state;

FIG. 5 is a cross-sectional view, similar to FIG. 4, illustrating a free turning movement of a door handle of the door lock mechanism in an unlocked state;

FIG. 6 is a cross-sectional view, similar to FIG. 3, illustrating the door lock mechanism in accordance with the first embodiment of the present invention, wherein the door lock mechanism is in a locked state; and

FIG. 7 is an exploded perspective view of a second embodiment of the restraining plate of the door lock mechanism in accordance with the present invention.

### DETAILED DESCRIPTION OF THE PREFERRED EMBODIMENTS

Preferred embodiments of the present invention are now to be described hereinafter in detail.

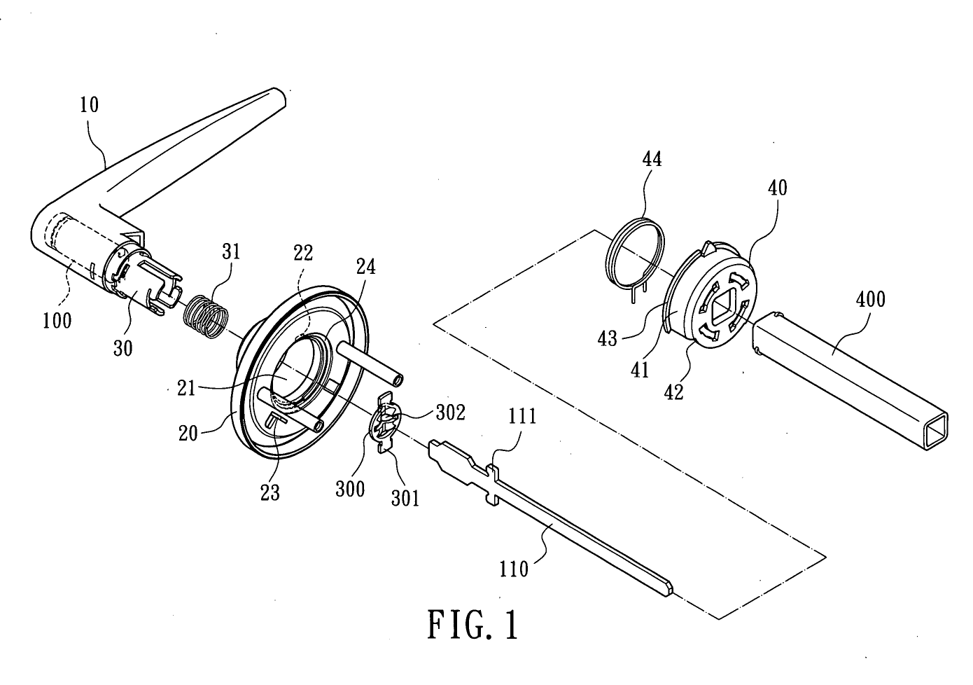

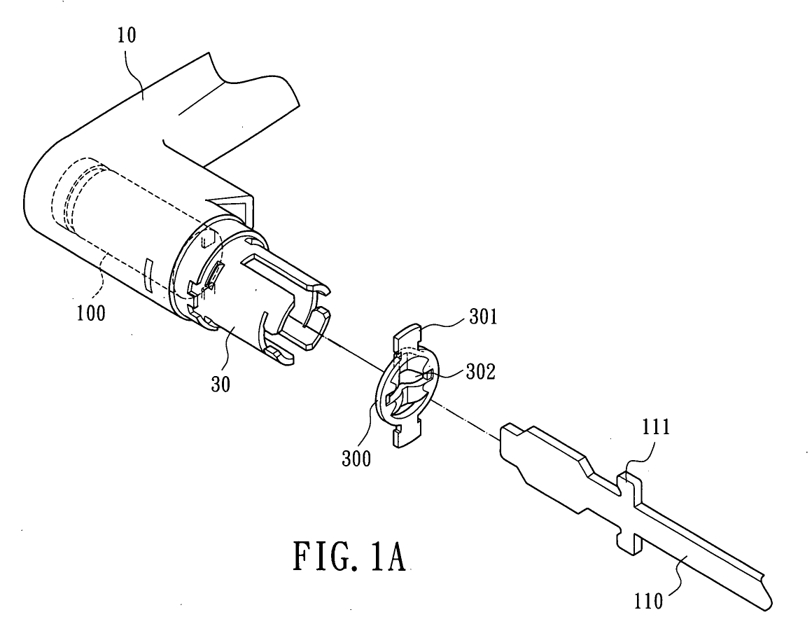

Referring initially to FIGS. 1 through 3, a door lock mechanism in accordance with the present invention comprises a door handle (an outer door handle 10 in this embodiment), a lock core assembly 100, a locking/unlocking control bar 110, a rose escutcheon 20, a spindle 30, and a return disc 40. The lock core assembly 100 is mounted to the outer door handle 10 to form an integral unit that is mounted by a mounting plate of the rose escutcheon 20 to a side of a door (not shown). The mounting plate is a separate member provided in the rose escutcheon 20, and has an ordinary or common form. An end of the spindle 30 is securely received in the mounting plate and the outer door handle 10, and the return disc 40 is mounted on the other end of the spindle 30. The spindle 30 includes a pair of longitudinal slots to engage with a restraining plate 300. Furthermore, the return disc 40 includes an axial hole through which an actuating member 400 is extended and in which the actuating member 400 is also fitted.

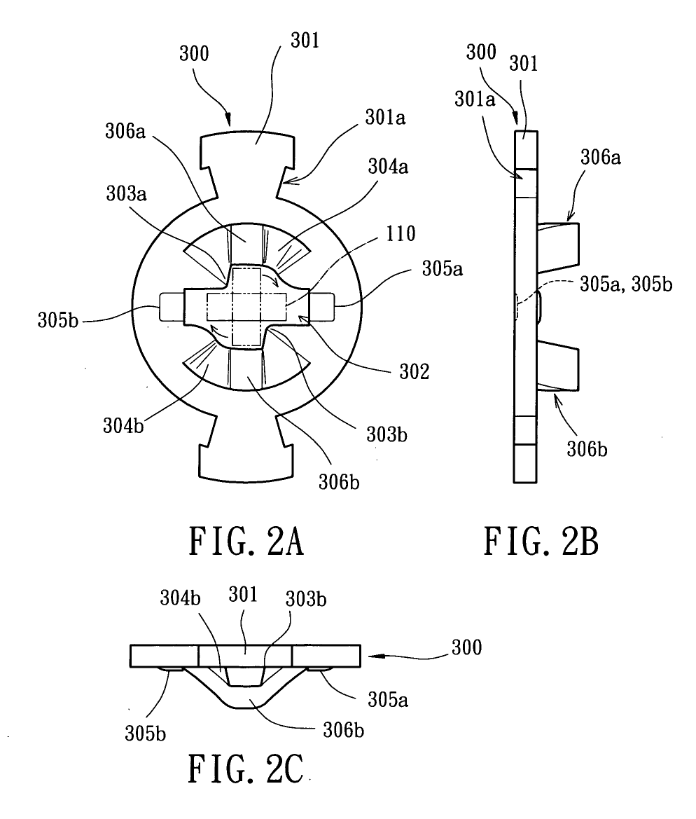

As illustrated in FIGS. 1, 1A and 2A-2C, the locking/unlocking control bar 110 is an elongated member having an end coupled to the lock core assembly 100. The locking/unlocking control bar 110 is preferably constructed from a one-piece member which is made from a relatively rigid metal material to withstand normal usage of turning operation. Further, the locking/unlocking control bar 110 is rotatably extended through the spindle 30, the restraining plate 300, the return disc 40, and the actuating member 400, as shown in FIG. 1. The locking/unlocking control bar 110 includes at least one lobe 111 (two in this embodiment). Preferably, the lobe 111 is integrally formed on the locking/unlocking control bar 110. In a preferred embodiment, the two lobes 111 are arranged symmetric on opposite edges of the locking/unlocking control bar 110.

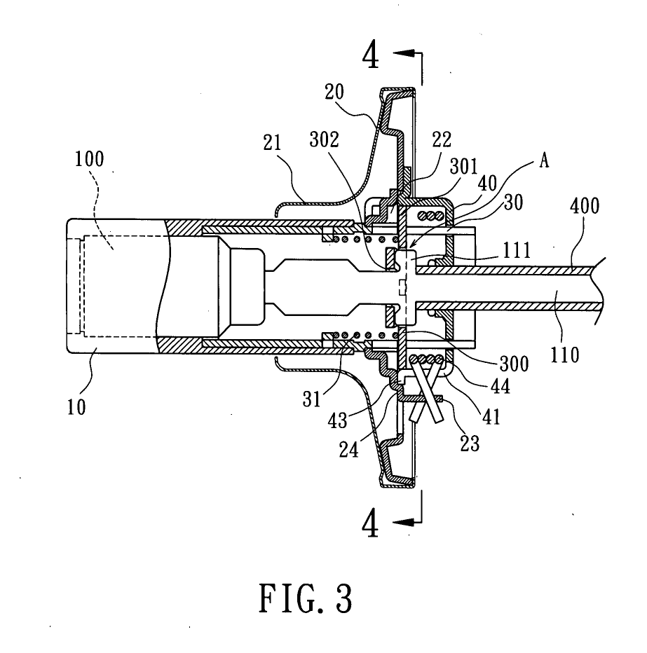

Still referring to FIGS. 1 and 3, the rose escutcheon 20 includes a neck 21 on a side thereof. Received in the other side of the rose escutcheon 20 is the mounting plate, and formed on which are at least one positioning groove 22 (two in this embodiment), at least two positioning plates 23, and a stepped portion 24. The rose escutcheon 20 has an ordinary or common form of the escutcheon. In assembling operation, the neck 21 of the rose escutcheon 20 is engaged with the outer door handle 10 after the lock core assembly 100 and the spindle 30 have been mounted to the outer door handle 10.

Still referring to FIGS. 1, 1A, 2A-2C and 3, the spindle 30 is a tubular member that receives a spring 31 for biasing the restraining plate 300 in the spindle 30 such that the restraining plate 300 can automatically move to an unlocked position from a lock position along a longitudinal direction of the locking/unlocking control bar 110. Conversely, the restraining plate 300 can move to the unlocked position from the lock position along the longitudinal direction of the locking/unlocking control bar 110 by turning the locking/unlocking control bar 110 in a reverse direction if the spring force of the spring 31 is overcome. It is understood that the unlocked position of the restraining plate 300 located in the spindle 30 is spaced apart a predetermined distance from the lock position along the longitudinal direction of the spindle 30.

Referring back to FIG. 2A, the restraining plate 300 has a circular form and a predetermined thickness thereof which is rigid and strong to withstand normal usage. In a preferred embodiment, the restraining plate 300 is formed in a single punching operation so as to simplify the steps in manufacture. The restraining plate 300 is a main body of an integrally formed metal plate including two engaging pieces 301 extended therefrom and an 8-shaped, elongated hole 302 formed therein. Formed in the 8-shaped, elongated hole 302 are a pair of limiting inner edges 303a, 303b, a pair of inclined guide peripheries 304a, 304b, a pair of positioning recesses 305a, 305b, and a pair of V-shaped grooves 306a, 306b. Each of the V-shaped grooves 306a, 306b has a V-shaped section across the 8-shaped, elongated hole 302. In a preferred embodiment, each of the limiting inner edges 303a, 303b has a relatively short diameter in the elongated hole 302. Each of the inclined guide peripheries 304a, 304b is correspondingly located in the V-shaped grooves 306a, 306b, and correspondingly connects with the positioning recesses 305a, 305b. Further, the spindle 30 is engaged with the return disc 40 to prevent disengagement of the spring 31 and the restraining plate 300. In this case, the spring 31 is in a compressed state to continuously bias the restraining plate 300 by a spring force, thereby controlling the axial position of the engaging piece 301 in relation to the positioning groove 22 of the mounting plate of the rose escutcheon 20, which will be described in greater detail below.

Still referring to FIGS. 2A and 3, the restraining plate 300 further includes at least one neck portion 301a which is integrally connected between the main body and one of the engaging pieces 301. When the spindle 30 and the restraining plate 300 are assembled, the engaging pieces 301 of the restraining plate 300 are correspondingly extended beyond the longitudinal slots of the spindle 30. In this manner, the engaging pieces 301 of the restraining plate 300 can be engaged with and disengaged from the positioning grooves 22 of the mounting plate of the rose escutcheon 20 in locking or unlocking operation. Furthermore, the neck portion 301a of the restraining plate 300 is engaged with one of the longitudinal slots of the spindle 30.

Still referring to FIGS. 1, 1A and 2A, the locking/unlocking control bar 110 extends through the 8-shaped, elongated hole 302 of the restraining plate 300 and engages therewith. The lobes 111 of the locking/unlocking control bar 110 rest in the V-shaped grooves 306a, 306b of the restraining plate 300 when the restraining plate 300 is located in the unlocked position arranged in the spindle 30. By referring to FIG. 2A, the limiting inner edges 303a, 303b can limit any reversed-turning movement of the locking/unlocking control bar 110, and the inclined guide peripheries 304a, 304b permit a turning movement of the locking/unlocking control bar 110, as indicated by the direction arrows in FIG. 2A. Turning the locking/unlocking control bar 110 cause the lobes 111 to pass through the inclined guide peripheries 304a, 304b of the restraining plate 300 by overcoming the spring force of the spring 31. Conversely, the lobes 111 of the locking/unlocking control bar 110 may rest in the positioning recesses 305a, 305b of the restraining plate 300 when the restraining plate 300 is changed to the lock position arranged in the spindle 30.

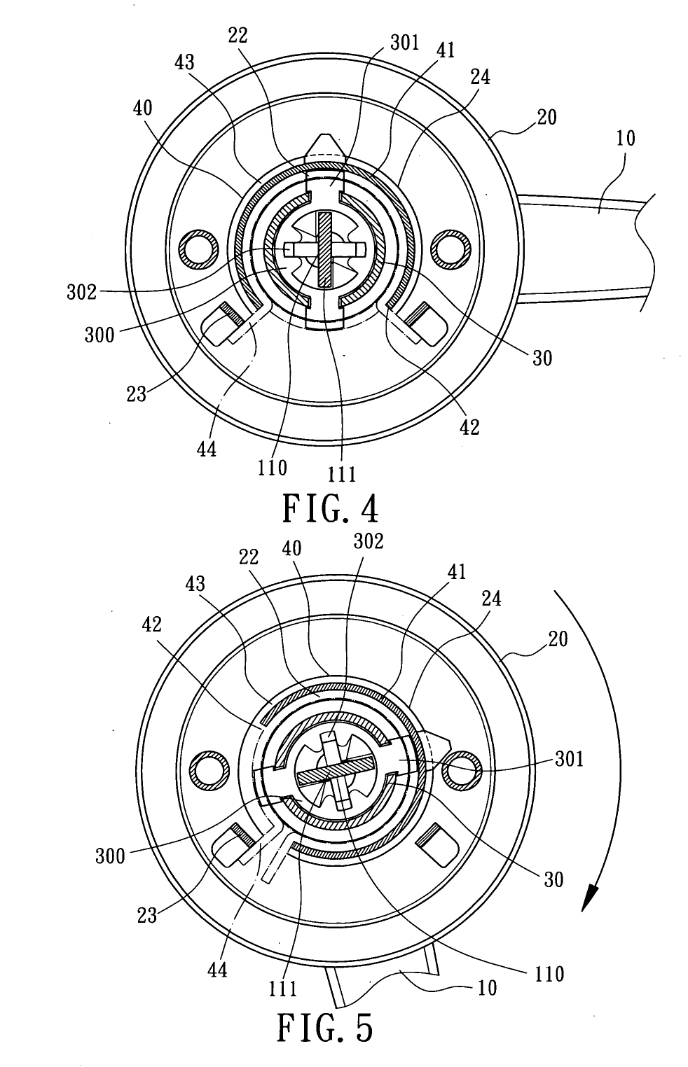

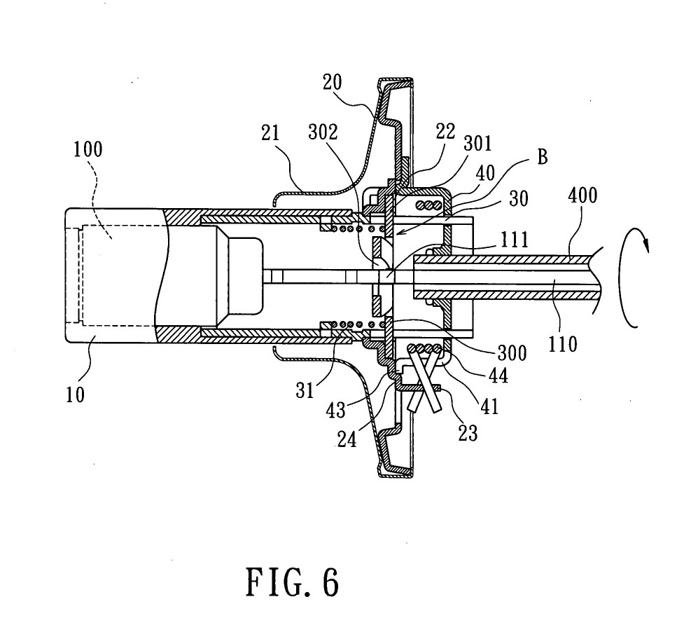

Turning now to FIGS. 3 through 5, when the door lock mechanism is in an unlocked state, the engaging pieces 301 of the restraining plate 300 are disengaged from the positioning grooves 22 of the mounting plate of the rose escutcheon 20 due to the facet that the unlocked position of the restraining plate 300 occurs. In this manner, the door lock mechanism permits a freely rotational movement of the outer door handle 10, as best indicated by the direction arrow in FIG. 5. Referring to FIG. 6, when the door lock mechanism is in a locked state, the engaging pieces 301 of the restraining plate 300 are respectively received in and thus restrained by the positioning grooves 22 of the mounting plate of the rose escutcheon 20 to thereby prohibit rotational movement of the outer door handle 10. It will be understood that the locking/unlocking control bar 110 is rotated a 90-degree angle about an axis of the restraining plate 300, as best indicated by the direction arrows in FIG. 2A. Consequently, the restraining plate 300 is moved toward the rose escutcheon 20 from the unlocked position (identified as “A” in FIG. 3) to the lock position (identified as “B” in FIG. 6). Thus, the outer door handle 10 cannot be turned and is in the locked state. When a correct key (not shown) is used to turn the lock core assembly 100 in an unlocking direction, the locking/unlocking control bar 110 is turned for unlocking operation. The lobes 111 of the locking/unlocking control bar 11 actuate the restraining plate 300 to move axially toward the return disc 40 until the engaging pieces 301 are disengaged from the positioning grooves 22 of the rose escutcheon 20, as shown in FIG. 3. In this unlocking state, the outer door handle 10 can be turned. The user may turn the correct key in the opposite direction (locking direction) to turn the locking/unlocking control bar 110 in an opposite direction to thereby axially move the restraining plate 300 in the opposite direction until the engaging pieces 301 of the restraining plate 300 are engaged in the positioning grooves 22 of the mounting plate of the rose escutcheon 20, as shown in FIG. 6.

Referring back to FIGS. 1 through 5, the return disc 40 is an integral member including an annular wall 41, a notch 42, and a flange 43. A return spring 44 is mounted in the return disc 40. More specifically, the return spring 44 is coaxially received in the annular wall 41 to reduce the space occupied by the door lock mechanism, thereby providing a compact design. Two ends of the return spring 44 are extended through the notch 42 of the return disc 40 and respectively attached to the positioning plates 23 of the mounting plate of the rose escutcheon 20 for returning the outer door handle 10. More specifically, when the door lock mechanism is in the unlocked state and the outer door handle 10 is turned, the return spring 44 is overcome and the spindle 30, the restraining plate 300 and the return disc 40 are turned, as shown in FIG. 5. When the outer door handle 10 is released, the outer door handle 10, the spindle 30, the restraining plate 300 and the return disc 40 are returned to their original position under the action of the return spring 44. Since the return spring 44 is directly received in the return disc 40, the assembling procedure is simple and the lock is thus compact.

As illustrated in FIGS. 1 and 3, an end of the actuating member 400 is extended through the return disc 40 to allow joint rotation of the actuating member 400 and the return disc 40. The other end of the actuating member 400 is coupled to a latch assembly (not shown) such that rotation of the outer handle 10 causes retraction of a latch bolt (not shown) of the latch assembly when the lock is in an unlocked state.

As illustrated in FIG. 3, to strengthen the engagement between the mounting plate of the rose escutcheon 20 and the return disc 40, the stepped portion 24 of the mounting plate of the rose escutcheon 20 is engaged with the flange 43 of the return disc 40. Thus, in addition to the engagement among the outer door handle 10, the spindle 30, and the return disc 40, the structure of the door lock mechanism is further strengthened by the engagement between the stepped portion 24 of the mounting plate of the rose escutcheon 20 and the flange 43 of the return disc 40.

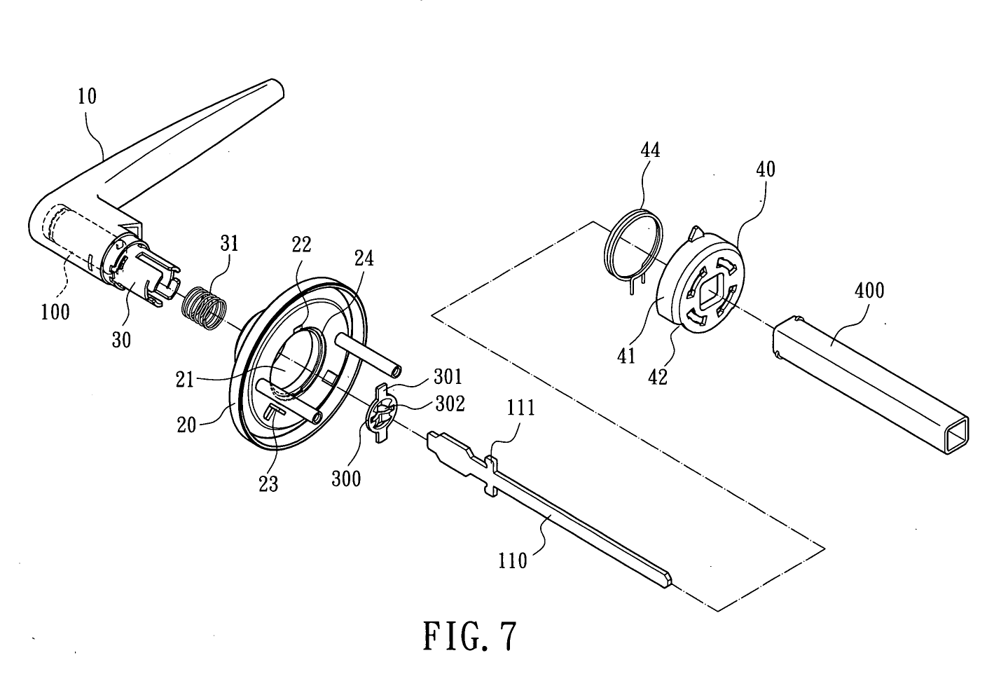

FIG. 7 illustrates a modified embodiment of the restraining plate 300 for use in the door lock mechanism in accordance with the present invention. In this embodiment, the flange 43 of the return disc 40 and the stepped portion 24 of the rose escutcheon 20 in the above embodiment are omitted to provide a simplified structure. In this embodiment, the neck portion of the restraining plate 300 may be further omitted and the structure of the restraining plate 300 is further simplified.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A door lock mechanism comprising:
a rose escutcheon including a mounting plate and at least one positioning groove provided on the mounting plate;
a door handle rotatably extending through the rose escutcheon and the mounting plate;
a spindle including a first end securely attached to the door handle and a second end to receive a spring, said spindle further including at least one longitudinal slot;
a restraining plate received in the second end of the spindle and biased by the spring, said restraining plate including at least one engaging piece and an 8-shaped, elongated hole in which to provide at least one limiting inner edge and at least one inclined guide periphery; and
a locking/unlocking control bar extending through the 8-shaped, elongated hole of the restraining plate, the limiting inner edge of the restraining plate limiting a turning movement of the locking/unlocking control bar in a first direction while the inclined guide periphery allowing a turning movement of the locking/unlocking control bar in a second direction, said locking/unlocking control bar including at least one lobe to engage with and to pass through the inclined guide periphery such that said lobe causes a longitudinal movement of the restraining plate from an unlocked position to a lock position by turning said locking/unlocking control bar;
wherein the engaging piece of the restraining plate is extended beyond the longitudinal slot of the spindle and is engaged in the positioning groove of the mounting plate of the rose escutcheon when the restraining plate is located in the lock position; the engaging piece of the restraining plate is disengaged from the positioning groove of the mounting plate of the rose escutcheon when the restraining plate is located in the unlocked position.

2. The door lock mechanism as claimed in claim 1, wherein the restraining plate including at least one V-shaped groove in which to form the inclined guide periphery.

3. The door lock mechanism as claimed in claim 1, wherein the restraining plate includes at least one positioning recess to receive the lobe of the locking/unlocking control bar when the locking/unlocking control bar is turned and the restraining plate is in the lock position.

4. The door lock mechanism as claimed in claim 1, wherein a neck portion is connected between a main body of the restraining plate and the engaging piece.

5. A restraining plate structure of a door lock mechanism, said restraining plate cooperating with a locking/unlocking control bar which causes a longitudinal movement of the restraining plate from an unlocked position to a lock position by turning said locking/unlocking control bar, comprising:
a main body;
at least one engaging piece radially extended from the main body, said engaging piece being engaged with or disengaged from a positioning groove of a mounting plate of a rose escutcheon when the restraining plate is located in the lock or unlocked position;
an 8-shaped, elongated hole formed on the main body, the locking/unlocking control bar extending through the 8-shaped, elongated hole;
a limiting inner edge formed in the 8-shaped, elongated hole; and
an inclined guide periphery formed in the 8-shaped, elongated hole, at least one lobe of the locking/unlocking control bar engaging with and passing through the inclined guide periphery;
wherein the limiting inner edge of the restraining plate limits a turning movement of the locking/unlocking control bar in a first direction while the inclined guide periphery allows a turning movement of the locking/unlocking control bar in a second direction.

6. The restraining plate structure as claimed in claim 5, further including at least one V-shaped groove in which to form the inclined guide periphery.

7. The restraining plate structure as claimed in claim 5, further including at least one positioning recess to receive the lobe of the locking/unlocking control bar when the locking/unlocking control bar is turned and the restraining plate is in the lock position.

8. The restraining plate structure as claimed in claim 5, further including a neck portion connected between the main body and the engaging piece.

9. A door lock mechanism comprising:
a rose assembly having a first side and a second side, said second side being provided with at least one positioning groove;
an outer door handle having a connecting end connected to said first side of said rose assembly;
a spindle having a first end and a second end, said first end connecting to said connecting end of said outer door handle, said second end having at least one engaging portion and at least one longitudinal slot formed thereon;
a spring received in said second end of said spindle;
a return disc having a bottom formed with a hole and at least one engaging slot thereon, said at least one engaging slot being engaged in said engaging portion of said spindle;
a restraining plate received in said second end of said spindle and biased by said spring, said restraining plate having at least one engaging piece, a central hole and at least one set of position controlling means formed adjacent to said central hole; and
a locking/unlocking control bar penetrating through said central hole of said restraining plate, with one end extending through said hole of said bottom and the other end placed in said second end of said spindle, said locking/unlocking control bar further including at least one lobe connectable to said at least one set of position controlling means;
wherein said at least one set of position controlling means of the restraining plate has a first engaging portion, a second engaging portion and a inclined guider formed between said first engaging portion and said second engaging portion;
wherein said at least one engaging piece of the restraining plate is movably placed in said longitudinal slot of the spindle; and
whereby said at least lobe of said locking/unlocking control bar is adapted to cause a longitudinal movement of said at least one engaging piece of said restraining plate from an unlocked position to a lock position with said positioning groove of said rose assembly by turning said locking/unlocking control bar.

10. The door lock mechanism as claimed in claim 9, wherein said return disc further including an annular side wall surrounding said bottom.

11. The door lock mechanism as claimed in claim 10, wherein said door lock mechanism further including a return spring caged in said return disc.

12. The door lock mechanism as claimed in claim 10, wherein said annular side wall of said return disc further including a notch, and said return spring further including two ends extending out of said notch.

13. The door lock mechanism as claimed in claim 12, wherein said rose assembly further including at least one positioning plate formed thereon for restraining said two ends of said return spring.

14. The door lock mechanism as claimed in claim 9, wherein the return disc further including a flange formed on the distal end of said annular side wall.

15. The door lock mechanism as claimed in claim 14, wherein the rose assembly escutcheon further including hollow neck formed thereon, a stepped portion formed on said second side of said rose assembly and being adjacent to said hollow neck for engaging with said flange of said return disc.

16. The door lock mechanism as claimed in claim 9, wherein said locking/unlocking control bar further including a pair of lobes symmetrically arranged thereon.

17. The door lock mechanism as claimed in claim 9, wherein said position controlling means including a pair of the first engaging portions and a pair of the second engaging portions.
